(19) United States
(12) Patent Application Publication
(10) Pub. No.: US 2017/0228849 A1
(43) Pub. Date: Aug. 10, 2017

(54) APPARATUSES AND METHODS FOR ACTIVITY-BASED RESOURCE MANAGEMENT, AND STORAGE MEDIUM THEREOF

(71) Applicant: MediaTek Inc., Hsin-Chu (TW)

(72) Inventors: Shih-Chieh HUANG, New Taipei City (TW); Jen-Chieh LO, Zhushan Township (TW); Ting-Chu HO, Taichung City (TW); Chun-Hsiung HU, Hsinchu City (TW)

(21) Appl. No.: 15/016,580

(22) Filed: Feb. 5, 2016

(51) Int. Cl. G06T 1/20; G06F 1/32; G06T 1/60

(52) U.S. Cl. CPC G06T 1/20; G06T 1/60; G06F 1/3287

(57) ABSTRACT

An electronic apparatus including a display device and a controller is provided. The display device selectively displays one of a plurality of pages of an application, which make up a user interface of the application. The controller determines a hardware setting that was previously applied to the displayed page, and allocates one or more hardware resources of the electronic apparatus to the application according to the hardware setting.

### BACKGROUND OF THE APPLICATION

Field of the Application

The application generally relates to resource management, and more particularly, to apparatuses and methods for activity-based resource management.

Description of the Related Art

An electronic device generally has a number of resources such as the display, processor, memory devices, hard disk drive, and so on, which can be used by any of the applications running on the system. However, when the electronic device is powered by a limited power source, like a battery, resource management becomes an important issue for reducing power consumption of the system.

In a conventional design, resources are managed according to the remaining power in the battery. All resources are available when the remaining power is greater than a threshold, and some resources may be deactivated or submitted to function in limited mode when the remaining power is less than the threshold.

In another conventional design, resources are managed in a per-application basis. For example, if an application (e.g., a gaming application) requires a great deal of resources, it may be preferable to allocate all the requested resources to the application; and if an application requires only a small amount of the resources, the system may allocate a small share of the resources to the application.

### BRIEF SUMMARY OF THE APPLICATION

It has come to our attention that the workload during the execution of an application may vary with different activities of the application. Thus, it is desirable to have a more flexible and robust way of resource management.

In an aspect of the application, an electronic apparatus comprising a display device and a controller is provided. The display device is configured to selectively display one of a plurality of pages of an application, which make up a user interface of the application. The controller is configured to determine a hardware setting that was previously applied to the displayed page, and allocate one or more hardware resources of the electronic apparatus to the application according to the hardware setting.

In another aspect of the application, a method for activity-based resource management, which is executed by an electronic apparatus, is provided. The method comprises the steps of: selectively displaying one of a plurality of pages of an application, which make up a user interface of the application; determining a hardware setting that was previously applied to the displayed page; and allocating one or more hardware resources of the electronic apparatus to the application according to the hardware setting.

In yet another aspect of the application, a non-transitory machine-readable storage medium comprising a computer program, when executed, causes an electronic apparatus to perform a method for activity-based resource management. The method comprises the steps of: selectively displaying one of a plurality of pages of an application, which make up a user interface of the application; determining a hardware setting that was previously applied to the displayed page; and allocating one or more hardware resources of the electronic apparatus to the application according to the hardware setting.

Other aspects and features of the present application will become apparent to those with ordinarily skill in the art upon review of the following descriptions of specific embodiments of the electronic apparatuses and the methods for activity-based resource management, and storage mediums thereof.

### BRIEF DESCRIPTION OF DRAWINGS

The application can be more fully understood by reading the subsequent detailed description and examples with references made to the accompanying drawings, wherein:

FIG. 1 is a block diagram illustrating an electronic apparatus according to an embodiment of the application;

FIG. 2 is a flow chart illustrating the method for resource management according to an embodiment of the application;

FIG. 3 is a diagram illustrating an exemplary timeline chart of an application execution according to an embodiment of the application;

FIGS. 4A and 4B show schematic diagrams of the displayed user interface associated with Activity1 and Activity2, respectively;

FIG. 5 is a diagram illustrating an exemplary timeline chart of an application execution according to another embodiment of the application; and

FIGS. 6A˜6C show schematic diagrams of the displayed user interface associated with View1˜View3, respectively.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof.

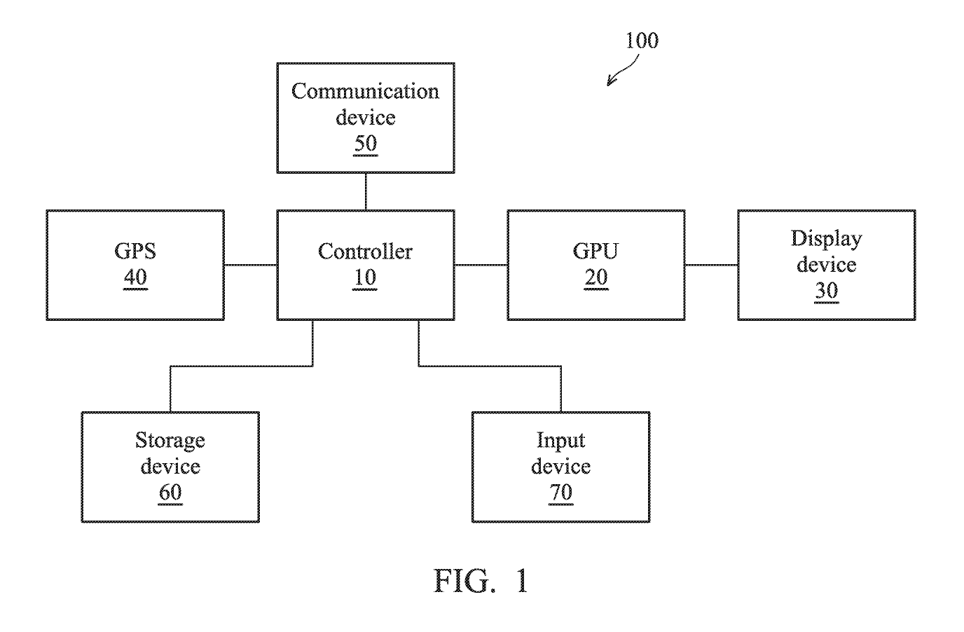

FIG. 1 is a block diagram illustrating an electronic apparatus according to an embodiment of the application. The electronic apparatus 100 may be a mobile phone, a smart phone, a panel Personal Computer (PC), a general-purpose computer, or another such apparatus. The electronic apparatus 100 includes a controller 10, a Graphics Processing Unit (GPU) 20, a display device 30, a Global Positioning System (GPS) 40, a communication device 50, a storage device 60, and an input device 70. The controller 10 may be a general-purpose processor (e.g., a Central Processing Unit (CPU)), a Micro Control Unit (MCU), an application processor, a Digital Signal Processor (DSP), or the like, for controlling the GPU 20 to send a series of frame data (e.g. representing text messages, graphics, images, etc.) to the display device 30, controlling the GPS 40 to receive location information of the electronic apparatus 100, controlling the communication device 50 for wired/wireless data communication, storing and retrieving data to and from the storage device 60, and receiving signals from the input device 70. In particular, the controller 10 coordinates the aforementioned operations of the GPU 20, the display device 30, the GPS 40, the communication device 50, the storage device 60, and the input device 70 for performing the method for activity-based resource management.

The GPU 20 is responsible for providing the function of graphics and image processing and for outputting the frame data to the display device 30. In another embodiment, the GPU 20 may be incorporated into the controller 10, serving as a specialized CPU die.

The display device 30 may be a Liquid-Crystal Display (LCD), Light-Emitting Diode (LED) display, or Electronic Paper Display (EPD), etc., for providing a display function. Alternatively, the display device 30 may be a touch-sensitive display which further comprises one or more touch sensors disposed thereon or thereunder for sensing touches, contacts, or proximities of objects, such as fingers or styluses.

The GPS 40 is a space-based navigation system that provides location and time information in all weather conditions, anywhere on or near the surface of the Earth where there is an unobstructed line of sight to four or more GPS satellites.

The communication device 50 is responsible for performing the functionality of wired and/or wireless data communications. For example, if the communication device 50 supports the function of wired data communication, it may include a cable modem, an Asymmetric Digital Subscriber Line (ADSL) modem, a Fiber-Optic Modem (FOM), an Ethernet network interface, or another wired interface. If the communication device 50 supports the function of wireless data communication, it may include an antenna, an RF device, and a baseband processing device.

A baseband processing device may be configured to perform baseband signal processing and control the communications between one or more subscriber identity cards and the RF device. The baseband processing device may contain multiple hardware components to perform the baseband signal processing, including Analog-to-Digital Conversion (ADC)/Digital-to-Analog Conversion (DAC), gain adjusting, modulation/demodulation, encoding/decoding, and so on. An RF device may receive RF wireless signals via the antenna, convert the received RF wireless signals to baseband signals, which are processed by the baseband processing device, or receive baseband signals from the baseband processing device and convert the received baseband signals to RF wireless signals, which are later transmitted via the antenna. The RF device may also contain multiple hardware devices to perform radio frequency conversion. For example, the RF device may comprise a mixer to multiply the baseband signals with a carrier oscillated in the radio frequency of the supported cellular technologies, wherein the radio frequency may be 2.4 GHz, 3.6 GHz, 4.9 GHz, or 5 GHz utilized in the Wireless Fidelity (WiFi) technology, or may be 900 MHz, 1800 MHz or 1900 MHz utilized in General Packet Radio Service (GPRS) or Enhanced Data rates for Global Evolution (EDGE) technology, or may be 900 MHz, 1900 MHz or 2100 MHz utilized in the Wideband Code Division Multiple Access (WCDMA) technology, or may be 900 MHz, 2100 MHz, or 2.6 GHz utilized in the Long Term Evolution (LTE), Time-Division LTE (TD-LTE), or LTE-Advanced (LTE-A) technology, or another radio frequency, depending on the Radio Access Technology (RAT) in use.

In another embodiment, the controller 10 may be a baseband processor of a baseband processing device in the communication device 50.

The storage device 60 is a non-transitory machine-readable storage medium, such as a memory, (e.g., a FLASH memory or a Non-volatile Random Access Memory (NVRAM)), or a magnetic storage device, (e.g., a hard disk or a magnetic tape), or an optical disc, or any combination thereof for storing the database of hardware settings of a plurality of pages, and storing instructions and/or program code of applications, communication protocols, and/or the method for activity-based resource management.

The input device 70 may comprise one or more buttons, a keyboard, a mouse, a touch pad, a video camera, a microphone, and/or a speaker, etc., serving as the Man-Machine Interface (MIMI) for interaction with users.

It should be understood that the components described in the embodiment of FIG. 1 are for illustrative purposes only and are not intended to limit the scope of the application.

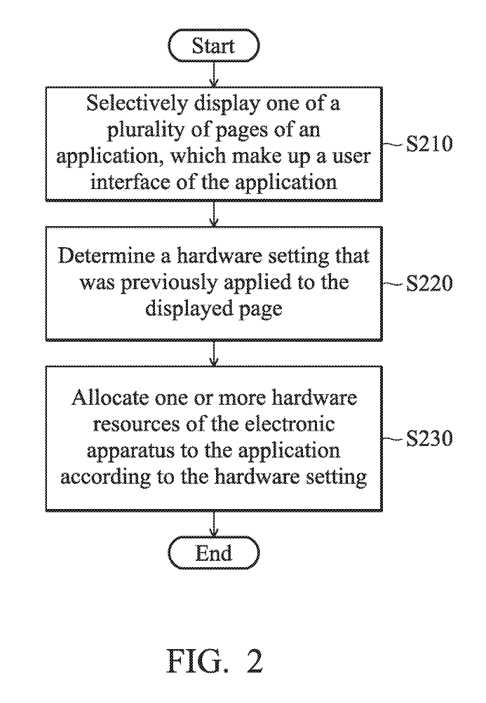

FIG. 2 is a flow chart illustrating the method for resource management according to an embodiment of the application. In this embodiment, the method for resource management is executed by an electronic apparatus, e.g., the electronic apparatus 100. To begin, the electronic apparatus selectively displays one of a plurality of pages of an application, which make up a user interface of the application (step S210). In one embodiment, the page is an Activity in the Andriod operating system. In another embodiment, the page is a View in the iOS operating system. It should be understood that the page may refer to a general concept of a full-screen window displayed on a portable/handheld device, and the technical term specified for the concept may vary in different operating systems. Therefore, the application is not limited to the aforementioned examples of the Andriod and iOS operating systems.

Next, the electronic apparatus determines the hardware setting that was previously applied to the displayed page, i.e., the current page of the application (step S220). The electronic apparatus may detect the current page by monitoring the logs generated during the execution of the application. The hardware setting may include the clock speed of a CPU/GPU, the number of cores of a CPU, the Frame Per Second (FPS) of a GPU, the brightness level of a display device, and the activation or deactivation of a GPS, etc. In one embodiment, the electronic apparatus may maintain a database for keeping the respective hardware setting for each page, and use the unique identifier (e.g., an identification number or a unique name string) of the current page to query the database for retrieving the corresponding hardware setting.

After that, the electronic apparatus allocates one or more hardware resources to the application according to the hardware setting (step S230). The hardware resources may include a CPU, a GPU, a display device, and a GPS, etc. For example, if the current page involves video playing or gaming scenario, a higher clock speed may be configured for the CPU/GPU, a higher brightness level may be configured for the display device, a higher number of cores may be configured for the CPU, and/or a higher FPS may be configured for the GPU.

In another embodiment, if the current page of the application is executed for the first time, the electronic apparatus may determine that there is no hardware setting previously applied to the displayed page, and apply a conventional on-demand governor to allocate hardware resources, in which the hardware resources are slowly or gradually allocated to the application according to the real-time demands from the execution of the application until the allocated hardware resources are sufficient for the execution of the application. Subsequently, the electronic apparatus may keep the final hardware setting corresponding to the current page in the database for later use, such as in step S220.

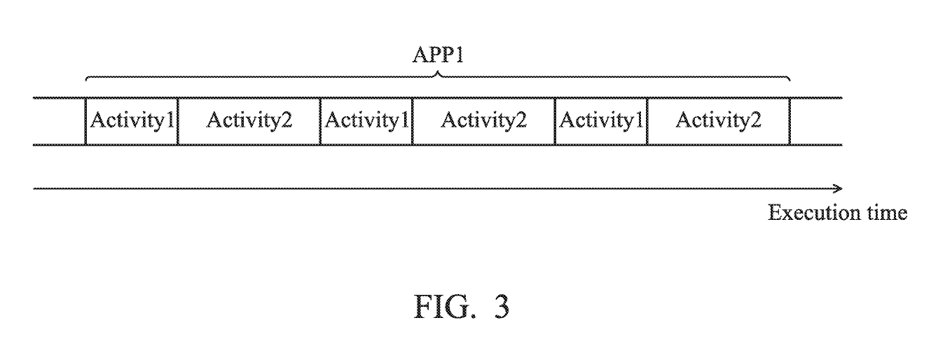

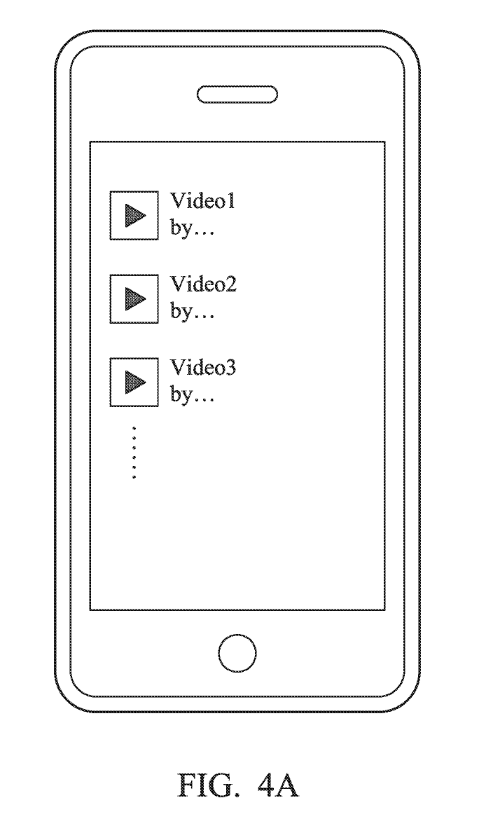

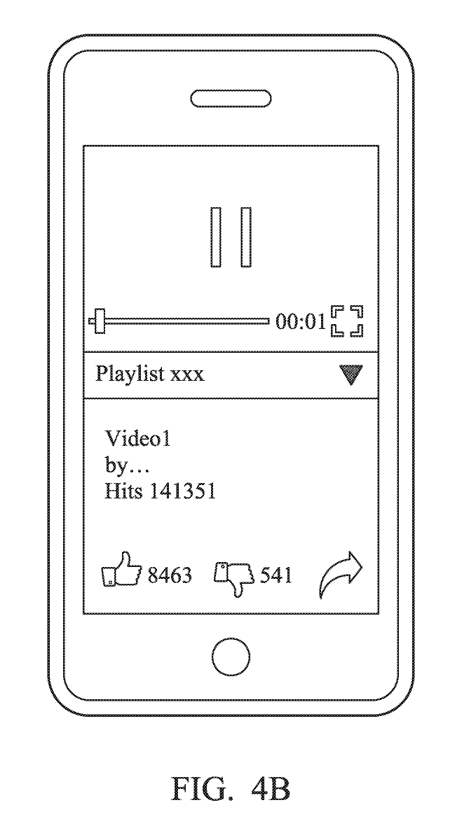

FIG. 3 is a diagram illustrating an exemplary timeline chart of an application execution according to an embodiment of the application. In this embodiment, the application is a video streaming application for the Android operating system. As shown in FIG. 3, there are two Activities (denoted as Activity1 and Activity2) involved in the execution of the application (denoted as APP1), wherein Activity1 is browsing a list of videos that may interest the user and Activity2 is playing a video selected from the list by the user. FIGS. 4A and 4B show schematic diagrams of the displayed user interface associated with Activity1 and Activity2, respectively.

Please note that Activity1 is allocated with fewer hardware resources as the browsing of a video list usually does not require high-end system performance, while Activity2 is allocated with more hardware resources as playing a video usually requires high-end system performance. For example, Activity1 may be allocated with a lower clock speed for the CPU/GPU, a smaller number of cores for the CPU, a lower FPS for the GPU, a lower brightness level for the display device, and/or deactivation of the GPS. Activity2 may be allocated with a higher clock speed of the CPU/GPU, a greater number of cores of the CPU, a higher FPS of the GPU, a higher brightness level of the display device, and/or deactivation of the GPS. That is, the hardware setting of Activity2 may cause more power consumption than the hardware setting of Activity1. However, in the present application, the hardware setting will be updated dynamically to save power in response to the change of the current activity, even when the remaining power in the battery of the electronic apparatus is still sufficient (i.e., the electronic apparatus is not operating in the power-saving mode).

In another embodiment, if the remaining power in the battery is still sufficient (e.g., 95% of full power), the electronic apparatus may remain to use the hardware setting of Activity2 for allocating the hardware resources even when the current activity has changed from Activity2 to Activity1.

It should be understood that the Activities described in the embodiment of FIG. 3 are for illustrative purposes only and are not intended to limit the scope of the application. In another embodiment, there may be more than 2 Activities involved in the execution of an application. Alternatively, the Activities may be replaced with Views when the application is executed in the iOS operating system.

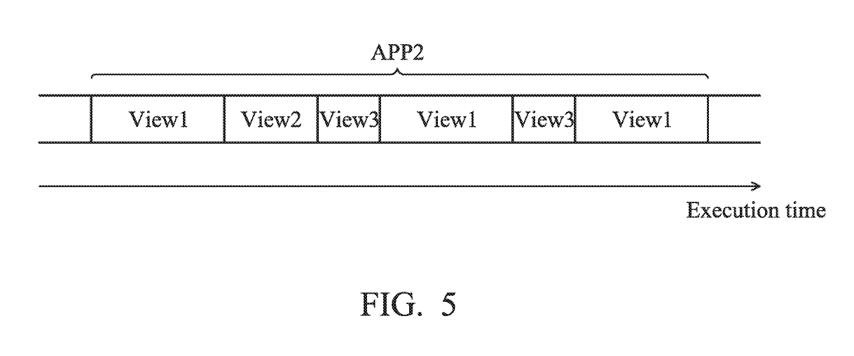

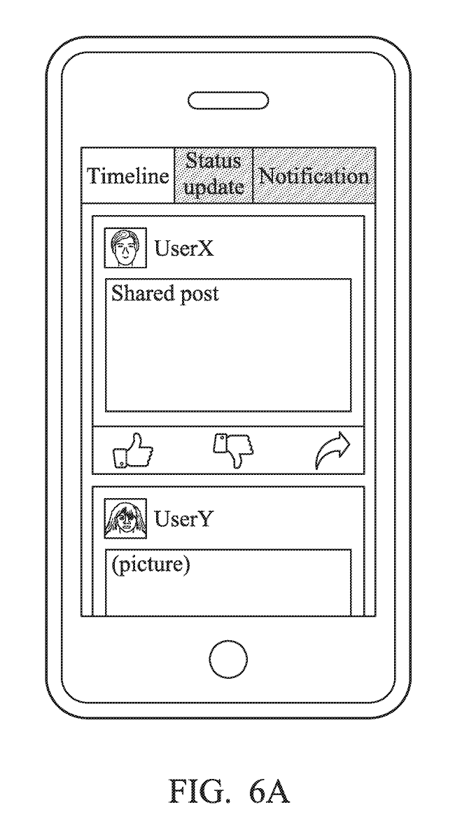

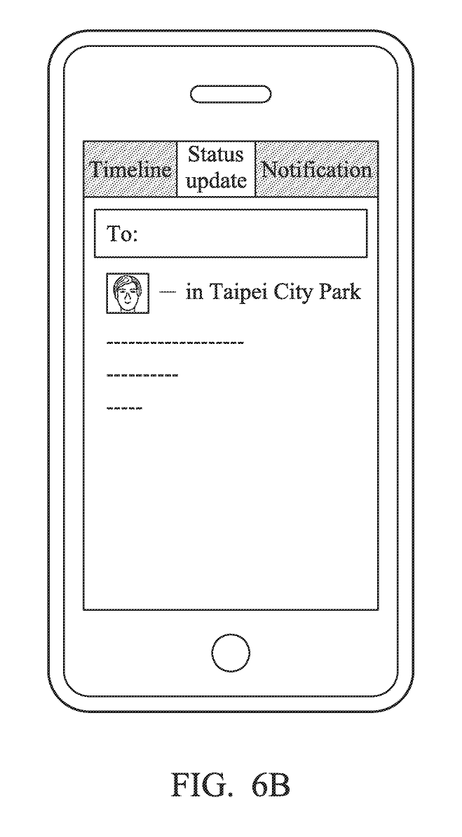

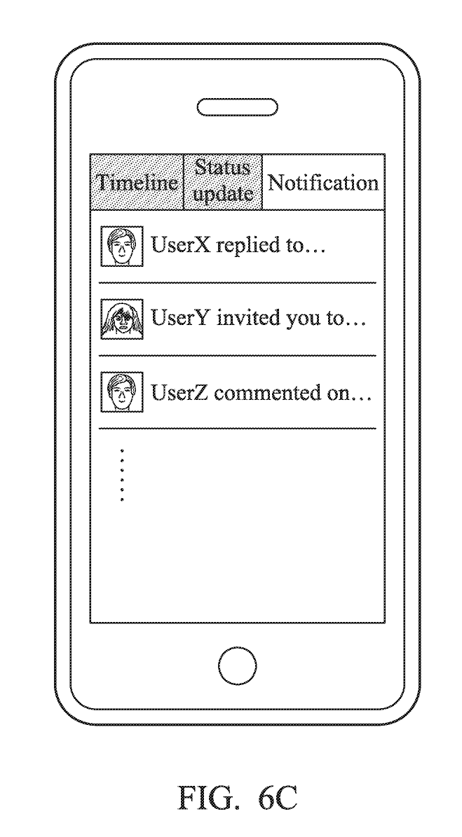

FIG. 5 is a diagram illustrating an exemplary timeline chart of an application execution according to another embodiment of the application. In this embodiment, the application is a social networking application (e.g., Facebook) for the iOS operating system. As shown in FIG. 3, there are three Views (denoted as View1, View2, and View3) involved in the execution of the application (denoted as APP2), wherein View1 is a View of browsing a timeline of posts from self and friends, View2 is a View of editing the status update with check-in, and View3 is a View of browsing notifications. FIGS. 6A˜6C show schematic diagrams of the displayed user interface associated with View1˜View3, respectively.

Please note that View2 may be allocated with activation of the GPS, while View1 and View3 may be allocated with deactivation of the GPS, since View1 and View3 do not require constant updates on the location of the electronic apparatus. Also, in contrast to View2 and View3, View1 may be allocated with a higher clock speed for the CPU/GPU, a greater number of cores for the CPU, a higher FPS for the GPU, and/or a higher brightness level for the display device, since View1 may involve video-playing or high-resolution picture display.

In view of the forgoing embodiments of FIGS. 3, 4A, 4B, 5, and 6A˜6C, it will be appreciated that the present application realizes fast and finer-grained resource management by allowing the electronic apparatus to keep and apply the hardware setting on a per-page basis instead of per-application basis with the conventional on-demand governor. Advantageously, this greatly reduces the power consumption of the electronic apparatus and improves the user experience towards the smoothness of the system.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. An electronic apparatus, comprising:
a display device, configured to selectively display one of a plurality of pages of an application, which make up a user interface of the application; and
a controller, configured to determine a hardware setting that was previously applied to the displayed page, and allocate one or more hardware resources of the electronic apparatus to the application according to the hardware setting.

2. The electronic apparatus of claim 1, wherein the hardware resources comprise at least one of the following:
the controller;
the display device;
a Graphics Processing Unit (GPU); and
a Global Positioning System (GPS).

3. The electronic apparatus of claim 2, wherein the hardware setting comprises at least one of the following:
a clock speed of the controller or the GPU;
a number of cores of the controller;
a Frame Per Second (FPS) of the GPU;
a brightness level of the display device; and
activation or deactivation of the GPS.

4. The electronic apparatus of claim 1, wherein the page is an activity in the Andriod operating system, or a view in the iOS operating system.

5. The electronic apparatus of claim 1, wherein the hardware setting is determined by querying a database storing the hardware setting that was previously applied to the displayed page.

6. The electronic apparatus of claim 1, wherein the controller is further configured to allocate one or more of the hardware resources to the application according to a real-time demand from an execution of the application, in response to determining that there is no hardware setting previously applied to the displayed page.

7. The electronic apparatus of claim 1, wherein, in response to the displayed page being switched to another page by the display device, the controller is further configured to determine another hardware setting that was previously applied to the other page, and update the allocation of the hardware resources to the application according to the other hardware setting.

8. The electronic apparatus of claim 7, wherein the update of the allocation of the hardware resources is performed when the electronic apparatus is not operating in a power-saving mode and the hardware setting causes more power consumption than the other hardware setting.

9. The electronic apparatus of claim 1, wherein, in response to the displayed page being switched to another page by the display device, the controller is further configured to determine whether a remaining power in a battery of the electronic apparatus is greater than a predetermined threshold, and remain the allocation of the hardware resources to the application according to the hardware setting when the remaining power in the battery of the electronic apparatus is greater than the predetermined threshold.

10. A method for activity-based resource management, which is executed by an electronic apparatus, the method comprising:
selectively displaying one of a plurality of pages of an application, which make up a user interface of the application;
determining a hardware setting that was previously applied to the displayed page; and
allocating one or more hardware resources of the electronic apparatus to the application according to the hardware setting.

11. The method of claim 10, wherein the hardware resources comprise at least one of the following:
the controller;
the display device;
a Graphics Processing Unit (GPU); and
a Global Positioning System (GPS).

12. The method of claim 11, wherein the hardware setting comprises at least one of the following:
a clock speed of the controller or the GPU;
a number of cores of the controller;
a Frame Per Second (FPS) of the GPU;
a brightness level of the display device; and
activation or deactivation of the GPS.

13. The method of claim 10, wherein the page is an activity in the Andriod operating system, or a view in the iOS operating system.

14. The method of claim 10, wherein the hardware setting is determined by querying a database storing the hardware setting that was previously applied to the displayed page.

15. The method of claim 10, further comprising:
allocating one or more of the hardware resources to the application according to a real-time demand from an execution of the application, in response to determining that there is no hardware setting previously applied to the displayed page.

16. The method of claim 10, further comprising:
in response to the displayed page being switched to another page by the display device, determining another hardware setting that was previously applied to the other page and updating the allocation of the hardware resources to the application according to the other hardware setting.

17. The method of claim 16, wherein the update of the allocation of the hardware resources is performed when the electronic apparatus is not operating in a power-saving mode and the hardware setting causes more power consumption than the other hardware setting.

18. The method of claim 10, further comprising:
in response to the displayed page being switched to another page by the display device, determining whether a remaining power in a battery of the electronic apparatus is greater than a predetermined threshold, and remaining the allocation of the hardware resources to the application according to the hardware setting when the remaining power in the battery of the electronic apparatus is greater than the predetermined threshold.

19. A non-transitory machine-readable storage medium comprising a computer program, when executed, causes an electronic apparatus to perform a method for activity-based resource management, wherein the method comprises:
selectively displaying one of a plurality of pages of an application, which make up a user interface of the application;
determining a hardware setting that was previously applied to the displayed page; and
allocating one or more hardware resources of the electronic apparatus to the application according to the hardware setting.
